(19) United States
(12) Patent Application Publication
(10) Pub. No.: US 2010/0245937 A1
(43) Pub. Date: Sep. 30, 2010

(54) Method and System for Improving Output Quality of Image Forming Devices

(76) Inventors: Mark Joseph Edwards, Lexington, KY (US); Anthony Michael King, Lexington, KY (US); Michael Ray Wedding, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/410,948

(22) Filed: Mar. 25, 2009

(51) Int. Cl. H04N 1/04; G06K 9/40

(52) U.S. Cl. 358/474; 382/254

(57) ABSTRACT

The invention includes a method and system for improving the output quality of an image forming device. The method includes comparing an amount of speckle present in the images with a predefined amount of speckle. Thereafter, it is evaluated whether an adjustment of an angle of inclination of an image capture assembly in the image forming device is required for improving the output quality of the images. Accordingly, the height of one or more spacers of a spacer assembly may be altered for inclining the image capture assembly with respect to a transparent surface on which an object to be scanned by the image forming device is placed. The height of the spacer assembly may be adjustable by a user or pre-set to an optimum level for reducing the speckle to a value less than or equal to the predefined amount of speckle.

### BACKGROUND

1. Field of the Invention

The present invention relates generally to image forming devices, and more particularly, to a method and system for improving the output quality of the image forming devices.

2. Description of the Related Art

An image forming device produces an image of an object or a document containing text, graphics, or a combination thereof. A scanner is an example of an image forming device. Such devices include a light source and an optical system within a bar or a carriage assembly, also referred to as a scan bar assembly. A scan bar in the scan bar assembly traverses the object or document for generating image data corresponding to the object or the document being scanned. The scan bar assembly also includes an image sensor circuit to gather the image data. The image sensor converts the generated optical image into an electrical signal. This electrical signal is then converted into digital information resulting in the formation of an image of the document. Examples of image sensors include, but are not limited to, Contact Image Sensors (CIS), Charge-Coupled Devices (CCD) and Complementary Metal-Oxide Semiconductor (CMOS) sensors. Accordingly, the scan bar may be or otherwise include a CCD array, a CIS array or a CMOS array.

CIS scan bars include an internal light guide that projects light from a Light Emitting Diode (LED) source on the object at an angle. Light reflected from the object passes through a lens on the scan bar assembly onto the CIS, placed in close proximity to the object being scanned. The CIS gathers the image data and converts it into a digital signal(s) corresponding to the digital image of the object scanned.

CIS scan bars are generally more cost effective in comparison with CCD scan bars. However, the CIS scan bars have a low depth of field. In other words, the quality of images of three-dimensional (3-D) objects produced by an image forming device employing a CIS scan bar is sometimes not of an acceptable quality. Further, CIS scan bars often do not effectively scan documents having different kinds of textures such as a textured-surface photo print. Different textures of the surface of documents or objects cause irregular reflections of light from a light guide of the scan bar assembly onto the lens. Such irregular light reflections often result in the digital image of the scanned object including a number of small, white spots, referred to as speckle. As can be seen, the occurrence of speckle degrades the output quality of the digital image.

The intensity of the speckle depends on the type of texture of the object, the construction of the scan bar in the device assembly and the angle of the light guide with respect to the object.

Some other contemporary image forming devices include a “despeckle” photo software tool solution for minimizing the speckle effect. Although the photo tool solution removes the speckle, it also diminishes other image details in the output.

### SUMMARY OF THE INVENTION

Embodiments of the present invention overcome shortcomings in prior image forming devices and thereby satisfy a need for a method and system to improve the output quality of the image forming device by minimizing the speckle in the produced image. The image forming devices according to the embodiments of the present invention do not diminish image details in any way and are cost effective.

According to exemplary embodiments of the present invention, there is provided a method including capturing one or more images through an image capture assembly, determining an amount of speckle in the images and comparing the speckle amount with a predefined amount of speckle. Further, the method may indicate, based upon the comparison, whether adjustment of an angle of inclination of the image capture assembly is required for reducing the amount of speckle in the images to an acceptable level. Embodiments of the present invention may include a mechanism for modifying the angle of inclination of the image capture assembly with respect to a transparent surface on which an object scanned is placed. In an embodiment of the present invention, the mechanism may include a height-adjustable spacer assembly that may be adjusted to induce an adjustment of an angle of inclination of the image capture assembly. The adjustment in the angle of inclination may result in a variation in the amount of speckle appearing in the images. Accordingly, the angle of inclination may be adjusted such that the amount of speckle in the images is reduced to a value less than or equal to the predefined amount of speckle thereby improving the output quality of the image forming device. Further, the spacers or the spacer assembly may be advantageously provided by the manufacturer of the image forming device instead of the manufacturer of the image capture assembly. Therefore, the spacers or the spacer assembly may be included in the image forming device without increasing the design cost of the image capture assembly.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a flowchart illustrating a method for improving output quality of an image forming device in accordance with an embodiment of the present invention;

FIG. 2 is a block diagram of an image forming device in accordance with an embodiment of the present invention;

FIG. 3A illustrates an exemplary scan bar assembly as is known in the art;

FIG. 3B illustrates a scan bar assembly in accordance with an embodiment of the present invention;

FIG. 4 is a side view of a scan bar assembly in accordance with an embodiment of the present invention;

FIG. 5 illustrates an image forming device with user-accessible leveler-type spacer assembly in accordance with an embodiment of the present invention;

FIG. 6 is an internal top plan view of a scan bar assembly with user-accessible leveler-type spacer assembly in accordance with an embodiment of the present invention;

FIG. 7 is a cross-sectional side view of a scan bar assembly with user-accessible leveler-type spacer assembly in accordance with an embodiment of the present invention;

FIG. 8 is a perspective view of a scan bar assembly with automatic leveler-type spacer assembly in accordance with another embodiment of the present invention;

FIG. 9 is a cross-sectional end view of a scan bar assembly with automatic leveler-type spacer assembly, in accordance with another embodiment of the present invention;

FIG. 10A is a sectional view of a screw leveler-type spacer assembly in accordance with an embodiment of the present invention; and

FIG. 10B is a sectional view of a screw leveler-type spacer assembly in accordance with an embodiment of the present invention; and

FIG. 10C is a perspective view of a screw leveler-type spacer assembly in accordance with an embodiment of the present invention.

### DETAILED DESCRIPTION OF DRAWINGS

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical and electrical configurations illustrated in the drawings are intended to exemplify embodiments of the invention and that other alternative configurations are possible.

Embodiments of the present invention provide a method and system for improving the output quality of an image forming device that produces one or more images of one or more objects. Examples of an image forming device include, but are not limited to, a scanner, a camera scan assembly or other imaging devices which incorporate same. Typically, scanners capture an object or a document image by capturing a one pixel-wide line per color plane at a time. Camera scan assemblies may be image capture systems that capture more than one pixel-wide line per color plane at a time. In other words, camera scan assemblies capture an X by Y pixel-sized image in one or more color planes at a time. For instance, camera-scan assemblies might include a digital still camera imaging system with a light source, mounted in a housing at some distance away from an object or a document position. Camera scan assemblies may be used for imaging the document at a faster rate than a line scanner.

According to an exemplary embodiment of the present invention, there is shown a method which includes capturing one or more images of an object or a document through an image capture assembly. Thereafter, an amount of speckle present in the images is determined. The determined speckle amount is then compared with a predefined amount of speckle. Further, based on the comparison, an indication is made whether an adjustment of an angle of inclination of the image capture assembly is required for improving the output quality of the images. The adjustment of the angle of inclination may include modifying the height of at least one of a plurality of spacers of a spacer assembly utilized in the image forming device for supporting the image capture assembly. The adjustment of the angle of inclination results in a variation in the angle of incidence of light projected on the objects thereby reducing the amount of speckle in the images and improving the output quality of the image forming device.

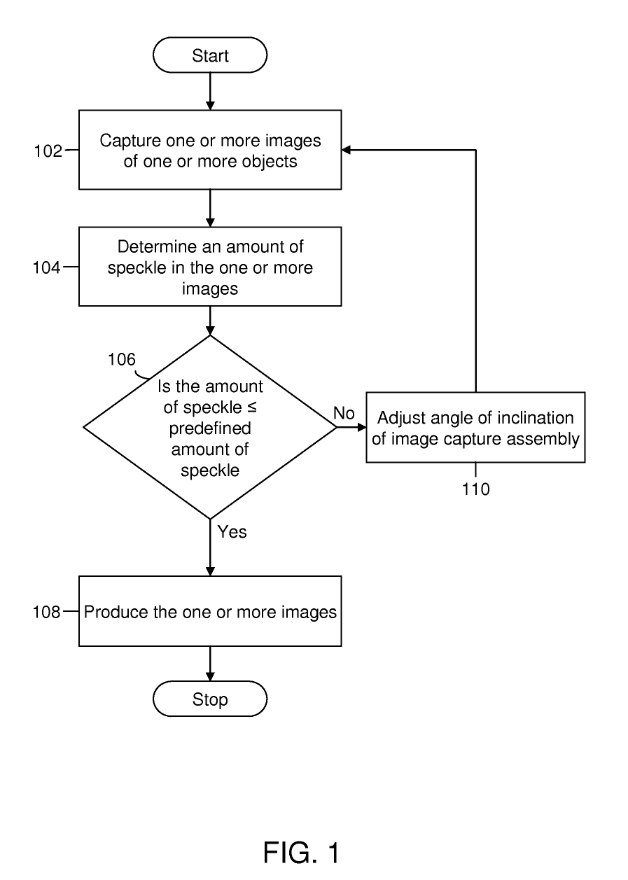

FIG. 1 is a flowchart illustrating a method for improving output quality of an image forming device in accordance with an embodiment of the present invention. At 102, one or images of one or more objects are captured by the image forming device. At 104, an amount of speckle is determined in the one or more images. In an embodiment of the present invention, one or more entropy values for the images may be determined in order to determine speckle in the images. The entropy value provides a measure of the amount of sharp white pixel point data present in an image.

In an embodiment of the present invention, the entropy value of an image may be calculated using Shannon Entropy measurement. Shannon entropy measurement is a measure of the degree of uncertainty of a discrete random variable. In this case, the value of an image pixel may be considered to be the discrete random variable. The value of the image pixel may be calculated as follows:

$$Entropy = - {\sum }_{i = 0}^{255} P ( i ) {log}_{2} [ P ( i ) ]$$

wherein P(i) is the probability of a pixel with value i occurring in an image and is defined as:

P(i)≈h(i)/N
wherein h(i) is the number of counts in histogram bin number ‘i’ and ‘N’ is the total number of pixels in the image. The histogram bin number ‘i’ refers to the number of the respective category class represented in the histogram. In various embodiments of the invention, the value of P(i) may vary from 0.0 to 1.0. The value of h(i) is calculated by taking a histogram of a two-dimensional image and counting the number of pixels with value ‘i’ occurring in an image. The value of ‘i’ corresponds to the range of RGB component values and lies in the range of 0 to 255.

In another embodiment of the present invention, speckle may be determined by using a gray-level co-occurrence matrix (GLCM). The method includes taking counts for intensity of pairs of neighboring pixels and placing the counts in a bin. In yet another embodiment of the present invention, speckle may be determined manually by a user by visually examining the image.

Further, at 106, the speckle determined in the images is compared with a predefined amount of speckle. If the determined amount of speckle is less than or equal to the predefined amount of speckle, then at 108, the image quality of the images is deemed acceptable and the images are produced by the image forming device. If the amount of speckle determined in the images is more than the predefined amount of speckle, then at 110, an angle of inclination of an image capture assembly in the image forming device is adjusted. The adjustment of the angle of inclination may include modifying the height of at least one of a plurality of spacers of a spacer assembly in the image forming device supporting the image capture assembly. The adjustment results in a variation of the effective angle of incidence of light projected on the objects for capturing the images of the objects, thereby resulting in a variation in the image data gathered by the image sensor. Thus, the adjustment of the angle of inclination induces a variation in the amount of speckle determined in the images.

It is understood that prior to adjusting the angle of inclination of the image capture assembly, the image forming device may indicate to a user, for example, that adjustment of the angle of inclination is warranted. Thereafter, the angle may be manually adjusted at 110. In an alternative embodiment of the present invention, following a determination that the amount of speckle in the image(s) captured exceeds the predefined speckle amount at 106, the angle of inclination of the image capture assembly may be automatically adjusted by the image forming device without providing a user indication.

Thereafter, the method is repeated until the amount of speckle determined in the images is less than or equal to the predefined amount of speckle. The method results in an improvement of the output quality of the image forming device by reducing the amount of speckle.

The predefined amount of speckle may be determined through empirical analysis. In various embodiments of the present invention, the predefined amount of speckle may vary according to the type of image forming device used or the type of texture of the object or the document to be scanned. The type of image forming device depends on the hardware components used and the construction of the scan bar assembly in the image forming device. An amount of speckle is determined in the images of the object or the document at different angles of inclination of the image capture assembly of the image forming device. Accordingly, the predefined amount of speckle may be viewed as an acceptable level of the amount of speckle determined in the images. In an embodiment of the present invention, the predefined amount of speckle may be a level acceptable to a user and therefore may vary among different users of the image forming device.

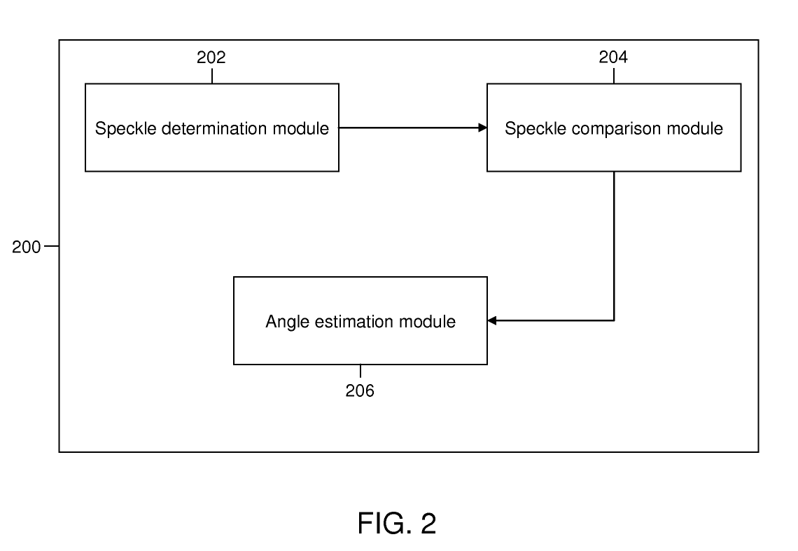

FIG. 2 is a block diagram of an image forming device 200 in accordance with an embodiment of the present invention. Image forming device 200 may include a speckle determination module 202, a speckle comparison module 204 and an angle estimation module 206.

A plurality of images generated by image forming device 200 are provided as input to speckle determination module 202. Speckle determination module 202 determines an amount of speckle in the images. In an embodiment of the present invention, speckle determination module 202 may determine entropy values for the images in order to determine the amount of speckle. In another embodiment of the present invention, entropy values may be determined only for one or more dark regions of the images in order to facilitate a faster and more accurate measurement of entropy in the images. Thereafter, speckle comparison module 204 compares the determined amount of speckle corresponding to the images with a predefined amount of speckle. In an embodiment of the present invention, speckle comparison module 204 may compare the entropy values with a predefined entropy value. In an embodiment of the present invention, the predefined entropy value may be in the range of about 0.0 to about 2.5.

If the amount of speckle determined in the images is more than the predefined amount of speckle, angle estimation module 206 may determine one or more angles of inclination of the image capture assembly. The angles of inclination are used to adjust the image capture assembly relative to a transparent surface, such as a glass surface, on which the documents to be processed by the image forming device are placed. In an embodiment of the present invention, the image capture assembly may be adjusted by the manufacturer while manufacturing the image forming device. In another embodiment of the invention, the image capture assembly may be adjusted manually by a user of the image forming device. Following adjustment of the image capture assembly, new image data is generated from the documents using the image capture assembly and speckle determination module 202 again measures the amount of speckle in the new image data and speckle comparison module 204 again compares the predefined amount of speckle with the amount of speckle determined from the new image data. The variation in the angle of inclination results in a variation in the angle of incidence of light projected on the documents thereby resulting in a variation in the amount of speckle. Thus, the one or more angles of inclination of the image capture assembly may be used to reduce the amount of speckle to a value less than or equal to the predefined amount of speckle.

It is understood that portions of the method of FIG. 1 as well as one or more of modules 202, 204 and 206 of FIG. 2 may be embodied in the form of a computer readable program code. Such computer readable program code may be executed by a processor located, for example, in imaging device 200 or in a computer communicatively connected to image forming device 200. It is further understood that image forming device 200 may include additional components or modules commonly found in a printer or all-in-one device, such as a user interface, print engine, a facsimile module and a controller for controlling such components/modules (not shown).

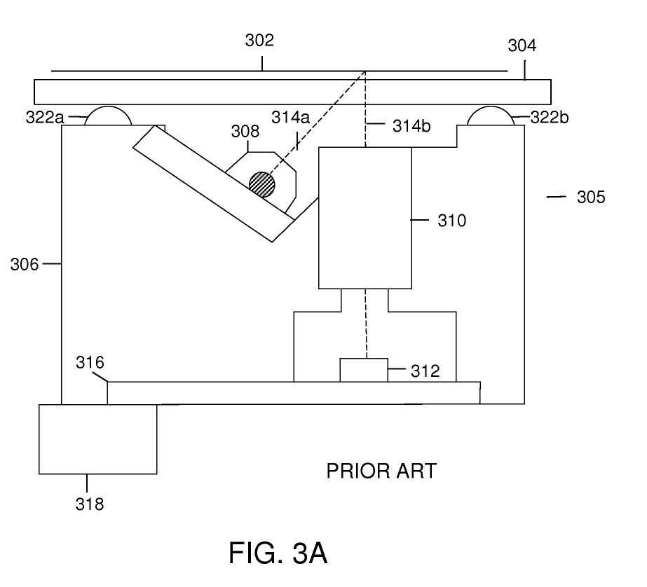

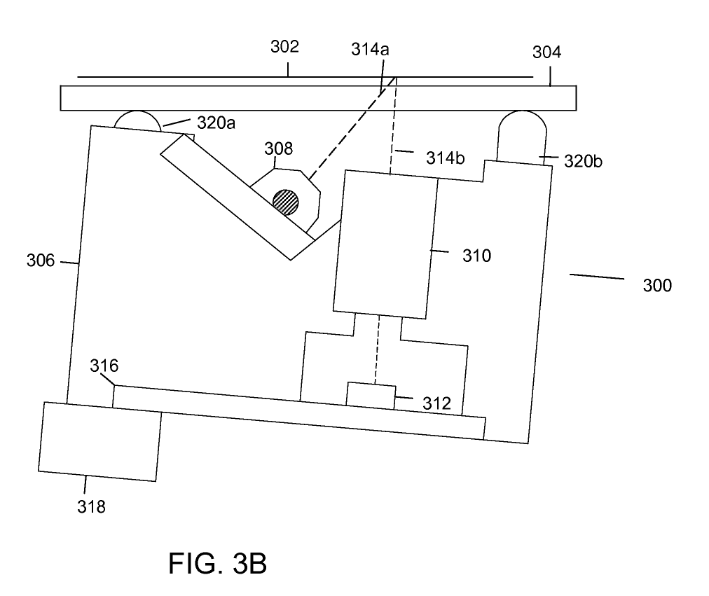

FIG. 3A illustrates an exemplary image forming device as is known in the art, including a transparent surface 304 on which a document 302 to be scanned may be placed. The image forming device may include a scan bar assembly 305 having a scan bar housing 306. Scan bar housing 306 may contain a light source 308, an array of lenses 310, a CIS chip 312 in optical communication with lens array 310, a Printed Circuit Board (PCB) 316 on which the CIS chip 312 is disposed, a connector 318 for communicating image data generated by CIS chip 312 to an external scanner drive, external memory, or an image processor or the like (not shown), and a plurality of spacers 322a and 322b, hereinafter referred to as spacers 322. Spacers 322 may be utilized to position scan bar housing 306 just beneath transparent surface 304 so that a gap exists between the top portion of scan bar housing 306 and transparent surface 304, thereby suitably positioning light source 308, lens array 310 and CIS chip 312 for use scanning document 302. In the known device, the amount of the gap between transparent surface 304 and scan bar housing 306 is defined by the upper portion of spacers 322 and is fixed and uniform across surface 304. In one known imaging device, for example, the uniform gap between transparent surface 304 and scan bar housing 306 provided by spacers 322 is approximately 1.2 mm.

Light emitted by light source 308 is projected on document 302 through transparent surface 304 and is represented by 314a. Further, the projected light is reflected back by document 302. The reflected light then passes through array of lens 310 onto CIS chip 312 and is represented by 314b. CIS chip 312 receives the optical image of document 302 generated by array of lens 310 and converts the optical image to an electrical signal. Thereafter, the electrical signal is converted into a digital image of the document. CIS chip 312 may contain a plurality of sensor elements.

FIG. 3B illustrates an image forming device having a scan bar assembly 300 in accordance with an embodiment of the present invention. The image forming device includes transparent surface 304 on which document 302 to be scanned is disposed, and scan bar housing 306. In scan bar housing 306 are light source 308 which directs light 314a towards document 302; an array of lenses 310 which focuses light 314b reflected from document 302; CIS chip 312 which is in optical communication with lens array 310, senses the focused, reflected light and generates electrical signals corresponding to the sensed light; PCB 316 on which CIS chip 312 is disposed; and connector 318 which facilitates the communication of the electrical signals generated by CIS chip 312 externally to scan bar assembly 300. Scan bar assembly 300 may further include spacers 320.

Scan bar assembly 300 is tilted with respect to transparent surface 304 such that a line normal to CIS chip 312 is at a non-zero angle to a line normal to transparent surface 304. The height of at least one spacer 320b is larger than the height of at least one other spacer 320a so as to provide scan bar assembly 300 with the desired tilt and non-zero angle between the normal to CIS chip 312 and the normal to surface 304. In an exemplary embodiment of the present invention, the heights of spacers 320a and 320b are fixed. In another exemplary embodiment of the present invention, the height of spacer(s) 320b is capable of being adjusted in order to vary the amount of tilt of scan bar assembly 300. This results in a selective variation in the angle of incidence of light projected on document 302 thereby resulting in a variation in the amount of speckle appearing in the image of the document. By suitably adjusting the height of one or more spacers 320, such as spacer 320b, the amount of speckle in the generated image may be reduced for a number of documents 302 having differing degrees of texture, to a value less than or equal to the predefined amount of speckle. As a result, the output quality of the image forming device is improved.

It is understood that in order to tilt scan bar housing 306 so as to vary the angle of inclination of scan bar assembly 300 relative to transparent surface 304, scan bar housing 306 may be urged upwardly towards transparent surface 304 within the imaging device until spacers 320 contact transparent surface 304. The imaging device may, for example, include a spring or other biasing mechanism to so urge scan bar assembly 300 upwardly. In this way, scan bar housing 306 may be relatively easily tilted as desired to achieve a desirably low amount of speckle in the image of the document scanned.

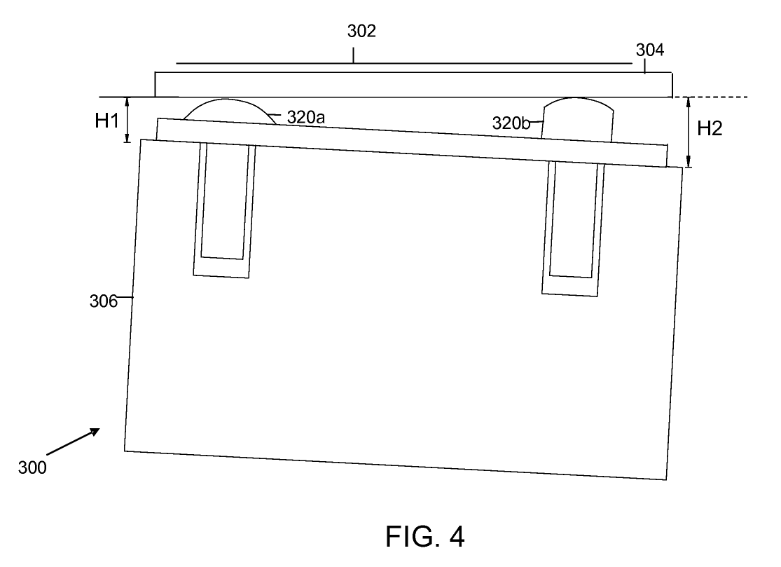

FIG. 4 is a side view of scan bar assembly 300. The components disposed within scan bar housing 306 are not shown for reasons of simplicity. FIG. 4 more clearly shows the height H2 of spacer 320a being less than the height Hi of spacer 320b which provides an uneven gap between scan bar housing 306 and transparent surface 304 as well as an angle of inclination between scan bar housing 306 and transparent surface 304. The angle of inclination results in a variation in the amount of speckle appearing in the captured images of the document 302.

As stated above, the height of one or more spacers 320b may be adjusted to vary the angle of inclination between scan bar housing 306 and transparent surface 304. Accordingly, the amount of speckle in the captured images of document 302 may be reduced to a desired value less than or equal to the predefined amount of speckle. In an embodiment of the present invention, the height of one or more spacers 320 may be adjusted by a user. In another embodiment of the invention, the height of spacers 320 may be pre-set to an optimum level that minimizes the amount of speckle in the images of widely used textured media types.

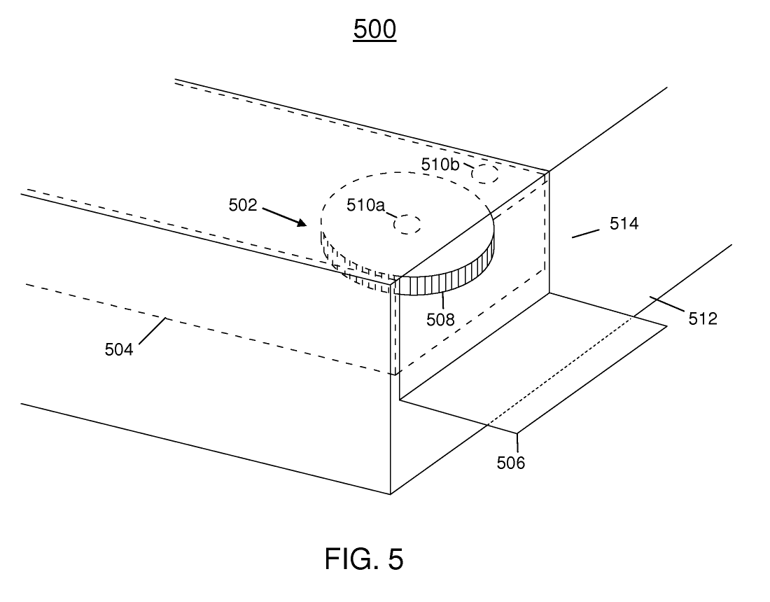

FIG. 5 illustrates a portion of an image forming device 500 with user-accessible leveler-type spacer assembly 502 in accordance with an embodiment of the present invention. The image forming device 500 may include an access door 506 positioned along a side portion 512 of image forming device 500. Image forming device 500 may further include scan bar housing 504 having spacer assembly 502 and scan bar assembly 514. Spacer assembly 502 includes a wheel 508 and at least one spacer such as spacer 510a and spacer 510b.

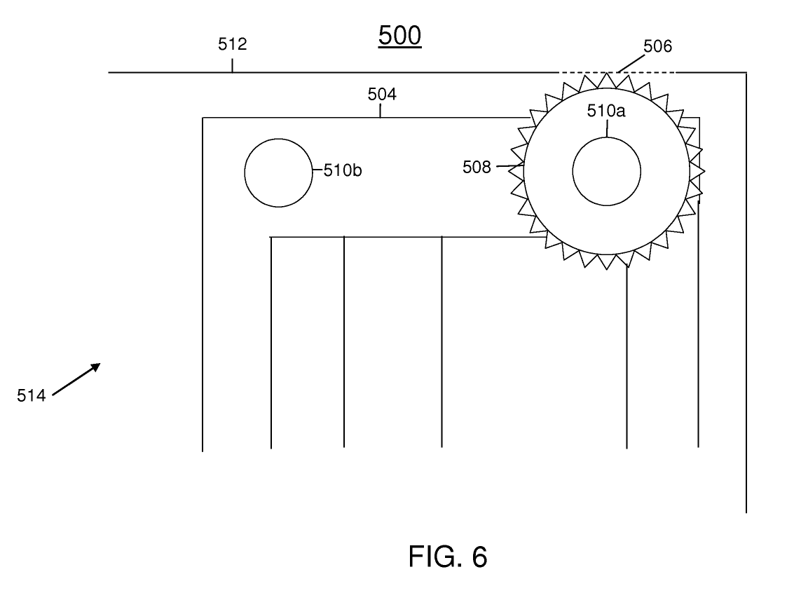

Access door 506 is provided in image forming device 500 to enable a user to adjust the height of at least one spacer 510 of spacer assembly 502. Spacer assembly 502 may include a plurality of spacers, such as spacers 510a and 510b, and a height adjustment mechanism. The height adjustment mechanism enables the user to modify the angle of inclination of scan bar assembly 514 with respect to a transparent surface (not shown in FIG. 5). In an embodiment of the present invention, the height adjustment mechanism may include wheel 508. Wheel 508 may be positioned relative to access door 56 for manipulation by a user, and operatively coupled to spacer 510a such that manual rotation of wheel 508 by a user moves at least one spacer 510a in the vertical direction. In another embodiment of the present invention, a plurality of wheels may be used to adjust the height of one or more spacers in spacer assembly 502. FIG. 6 is an internal top plan view of imaging device 500 of FIG. 5, showing scan bar assembly 514, scan bar housing 504, access door 506, wheel 508 and spacers 510a and 510b.

In another embodiment of the present invention, a screw may be provided for adjusting the height of spacer 510a.

In an embodiment of the present invention, the user-accessible leveler-type spacer assembly may be used in conjunction with a scan preview procedure. The user may adjust the height of spacer assembly 502 and check the scan preview simultaneously. If the scan result is not as desired, the user may further adjust the height of spacer assembly 502. In an embodiment of the present invention, the image forming device 500 may provide a range of the angle of inclination to the user for adjusting spacer assembly 502.

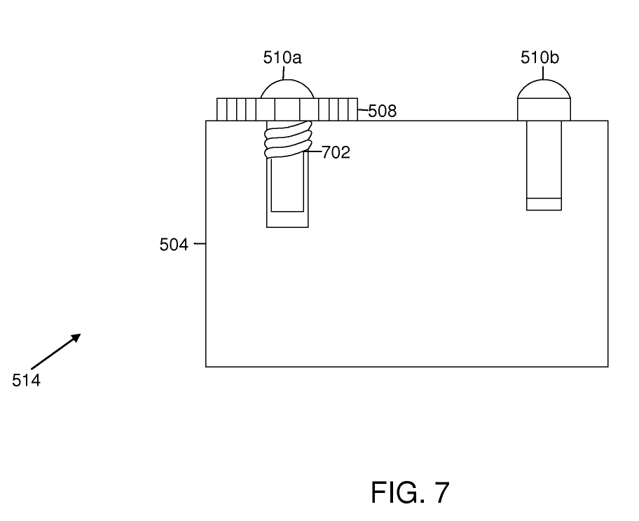

FIG. 7 is a cross-sectional side view of scan bar assembly 514 of FIGS. 5 and 6. FIG. 7 includes spacers 510a and 510b, and wheel 508. Wheel 508 may include a bore (not shown) defined through a central portion thereof, with the inner surface defining the bore being threaded. In addition, one or both of spacers 510a and 510b may include a spacer body having threaded portion 702 which engages with the threaded inner surface of wheel 508 such that manual rotation of wheel 508 moves spacer 510a in the vertical direction, relative to scan bar housing 504. In this way, by rotating wheel 508, scan bar housing 504 may be angularly tilted relative to the transparent surface of image forming device 500 to compensate for the effects of speckle caused by document 302 having a textured surface.

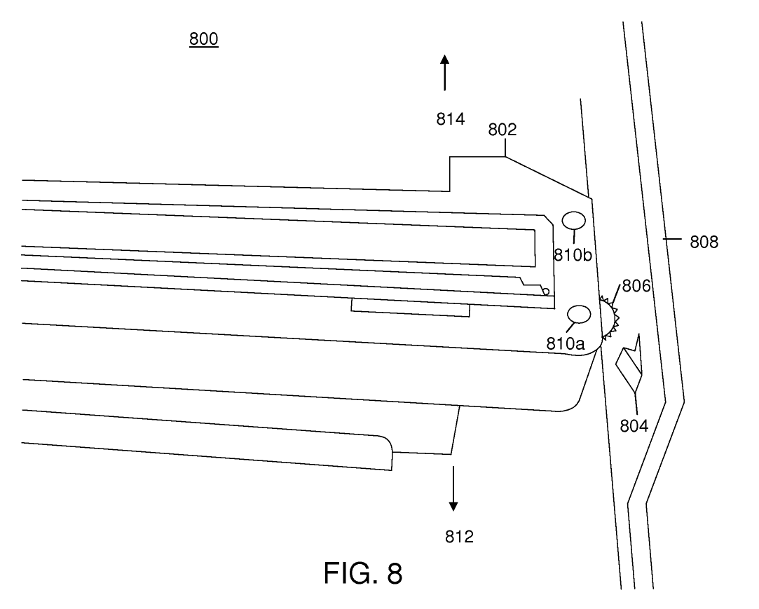

FIG. 8 is a perspective view of an imaging device 800 having scan bar assembly 802 with an automatic leveler-type spacer assembly in accordance with another embodiment of the present invention. Scan bar assembly 802 may include a rotatable gear 806 which is connected to one or more spacers 810, such as spacer 810a, by engagement such that rotation of gear 806 in one direction causes spacer 810 to move vertically. Imaging device 800 may further include a ratcheting lever 804 which extends outwardly from an inner surface of sidewall 808 of imaging device 800 when in a first position and is positioned substantially within sidewall 808 when in a second position. A biasing mechanism (not shown), such as a spring, may be disposed within ratcheting lever 804 so as to urge lever 804 outwardly from sidewall 808 when no other forces are applied to ratcheting lever 804. Gear 806 and ratcheting lever 804 form a ratchet mechanism for moving spacer 810a in a vertical direction.

When scan bar assembly 802 is driven into ratcheting lever 804 in the direction represented by 812, gear 806 engages with ratcheting lever 804. This engagement rotates gear 806 in a first direction which moves spacer 810a in the vertical direction to the next rest position. Each rest position is at a different spacer height. In various embodiments of the present invention, at least one spacer 810 is enmeshed with gear 806. As gear 806 moves along sidewall 808 passing over ratcheting lever 804, the spring mechanism inside ratcheting lever 804 makes ratcheting lever 804 return to the original position.

When scan bar assembly 802 is then driven in the direction represented by 814, gear 806 passes over ratcheting lever 804 thereby pushing ratcheting lever 804 such that it retracts into sidewall 808 without rotating gear 806. Thus, spacers 810 retain their original positions. When scan bar assembly 802 is again moved in the direction as represented by 812, spacer 810a moves to the next rest position. In an embodiment of the present invention, spacers 810 may return to the original position after attaining several intermediate rest positions.

A biasing mechanism, such as a spring (not shown in the figure), may be placed under the scan bar housing so as to exert an upward pressure on spacers 810 thereby holding spacers 810 in their rest positions. Thus, the ratcheting drive mechanism allows a one-way drive for moving spacers 810 in the vertical direction. The movement of spacers 810 in the vertical direction induces an angle of inclination of the scan bar assembly 802 with respect to a transparent surface on which an object is placed for scanning by image forming device 800.

In an embodiment of the present invention, the leveler-type spacer assembly may be placed outside the scan bar assembly 802.

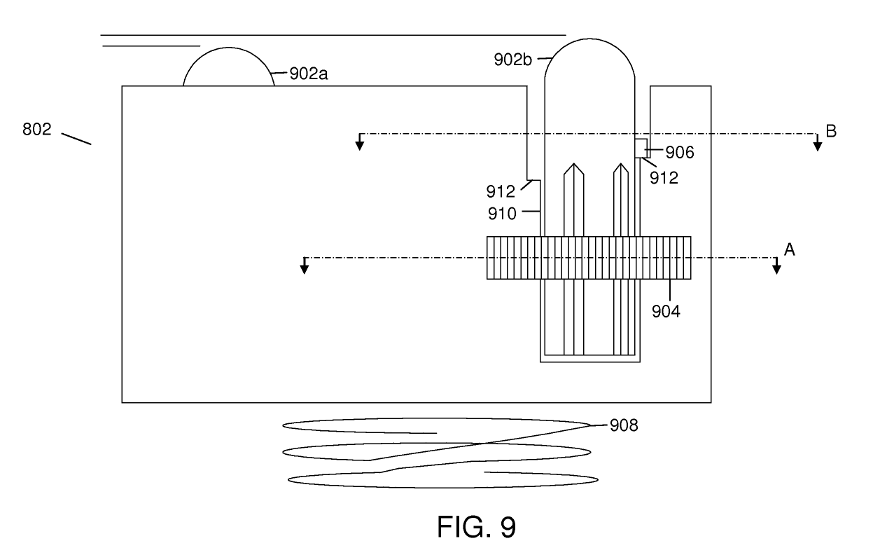

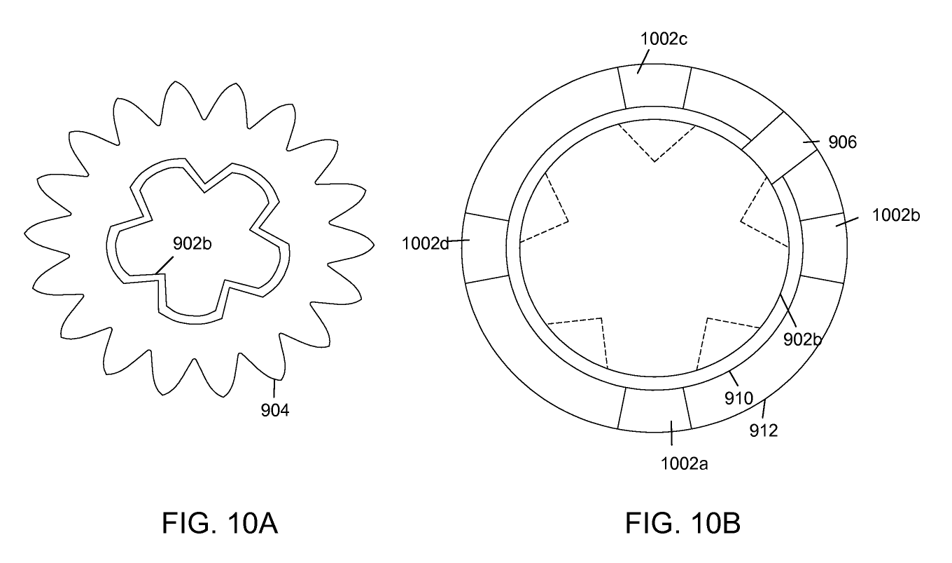

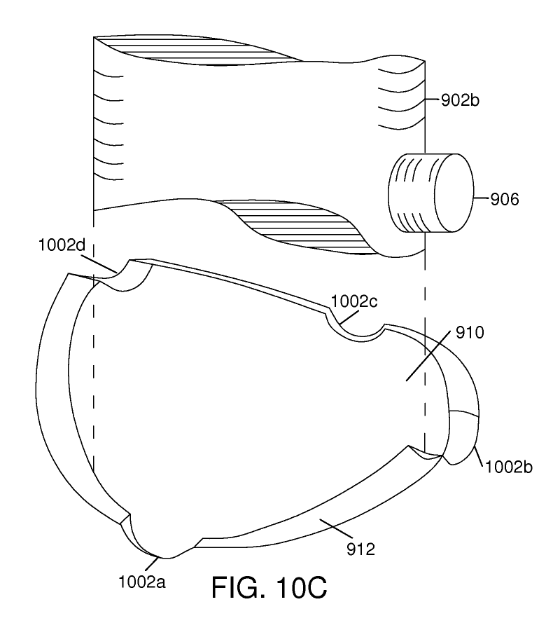

FIG. 9 is a cross-sectional end view of scan bar assembly 802 with the automatic leveler-type spacer assembly, in accordance with another embodiment of the present invention. Scan bar assembly 802 includes a plurality of spacers 902a and 902b hereinafter referred to as spacers 902, a gear 904, a peg 906, a spring 908, an inner shaft 910 and a circular cam surface 912 (best seen in FIG. 10c). Peg 906 is a molded, protruding part and integral with spacer 902b.

Spacers 902a and 902b have different heights such that scan bar assembly 802 is inclined at a non-zero angle relative to the transparent surface of the imaging device. Gear 904 may be used for driving the spacer 902b in the vertical direction into several rest positions. Peg 906 rides on circular cam surface 912 of inner shaft 910 of scan bar assembly 802 to enable spacer 902b to come to a rest position. As gear 904 rotates, peg 906 moves along circular cam surface 912 into a resting position. When gear 904 rotates again, peg 904 moves into the next resting position. Thus, height of spacer 902b may be varied.

Spring 908 induces an upward pressure on spacers 902 thereby pressing spacers 902 against the transparent surface. The spacer assembly is designed such that spacers 902 may return to the original positions owing to the upward pressure of spring 908 on spacers 902.

FIG. 10A is a sectional view of the screw leveler-type spacer assembly taken across a cross section represented by ‘A’ in FIG. 9 in accordance with an embodiment of the present invention. FIG. 10A includes gear 904 and spacer 902b.

FIG. 10B is a sectional view and FIG. 10C is a perspective view of the screw leveler-type spacer assembly taken across a cross section represented by ‘B’ in FIG. 9 in accordance with an embodiment of the present invention. FIGS. 10B and 10C include spacer 902b, peg 906, inner shaft 910, circular cam surface 912, and a plurality of rest divots 1002a, 1002b, 1002c and 1002d hereinafter referred to as rest divots 1002.

The rotational movement of gear 904 causes peg 906 to rotate while riding along circular cam surface 912. For example, peg 906 may come to a resting position at rest divot 1002a on circular cam surface 912. Rest divots 1002 are at unique resting positions. When gear 904 is rotated further, peg 906 moves to the next rest divot position, for example, peg 906 may move to rest divot 1002b, which is at a different vertical position. In various embodiments of the present invention, peg 906 may return to the original position, such as rest divot 1002a, after attaining a series of intermediate positions of different heights, such as rest divot 1002b, 1002c and 1002d as depicted in FIG. 10C. Thus, peg 906 enables modification of height of spacer 902b. In an exemplary embodiment of the present invention, peg 906 may have four resting positions. As peg 906 rotates along circular cam surface 912, spacer 902b moves into the next height position. Thus, spacer 902b may attain four different levels of height. At each height of spacer 902b, the angle of inclination of the scan bar assembly 802 and accordingly the speckle amount appearing in the images produced by the image forming device is varied. Thus, the speckle amount may be minimized at one of the angles of inclination of the scan bar assembly attained at these different levels of height. After moving to the three intermediate positions of peg 906, spacer 902b may then return back to an original position where the normal to the transparent surface is at a zero angle with respect to a normal to the scan bar assembly. It will be apparent to one skilled in the art that the number of resting position of different heights included in circular cam surface 912 may vary in accordance with various embodiments of the invention.

Experimental results reveal that the angle at which light is projected on the object to be scanned is a critical parameter in reducing speckle in the image of the object. Experiments were conducted using a black matte photo paper and entropy values of the images were measured for a set of angles of inclination of the scan bar assembly. The table below depicts the measured entropy of the scanned images for a range of angles of inclination of the scan bar assembly in accordance with an embodiment of the present invention.

TABLE 1
Entropy measurement

| ANGLE OF INCLINATION OF SCAN | MEASURED ENTROPY |
|---|---|
| BAR ASSEMBLY (DEGREES) | OF SCANNED IMAGES |
| 0° | 3.62 |
| 1.2° | 3.36 |
| 2.33° | 1.92 |

In accordance with various embodiments of the present invention, the minimum entropy or minimum speckle in the scanned images occurs when the angle of inclination of the scan bar assembly is varied within the range of 0° to 2.5°. The angle of inclination of the scan bar assembly may be varied in order to minimize the speckle appearing in the scanned images, thereby improving the output quality of the image forming device.

It is understood that the exemplary embodiments described above may be used in conjunction with a scan preview procedure. Specifically, the user may adjust the height of the one or more spacers and then check the scan preview substantially immediately following a scan of the document. If the scan image has an undesirably high amount of speckle, the user may further adjust the height of the spacer assembly. In an embodiment of the present invention, the image forming device may provide a range of the angle of inclination to the user for adjusting the spacer assembly.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A method for improving output quality of an image forming device producing one or more images of one or more objects, the method comprising:
capturing the one or more images of the one or more objects through an image capture assembly in the image forming device, the image capture assembly comprising a plurality of image sensor elements;
determining an amount of speckle in the one or more images;
comparing the amount of speckle with a predefined amount of speckle; and
indicating whether an adjustment of an angle of inclination of the image capture assembly is required, based on the comparison, wherein the adjustment of the image capture assembly improves the output quality of the image forming device.

2. The method according to claim 1, wherein determining the amount of speckle comprises determining one or more entropy values for the one or more images.

3. The method according to claim 1 further comprising repeating the capturing the one or more images, determining the amount of speckle in the one or more images, comparing the amount of speckle with the predefined amount of speckle and indicating whether the adjustment of the angle of inclination of the image capture assembly is required following the adjustment of the angle of inclination of the image capture assembly until the amount of speckle in the one or more images is less than or equal to the predefined amount of speckle.

4. The method according to claim 1 further comprising identifying one or more regions of the one or more objects, wherein the amount of speckle is determined for the one or more regions, the one or more regions being identified based on a predefined criterion.

5. An image forming device for producing one or more images of one or more documents, the image forming device comprising:
a transparent surface for supporting the one or more documents;
a scan bar assembly for scanning the one or more documents;
a spacer assembly comprising:
a plurality of spacers located between the scan bar assembly and the transparent surface for providing a gap between the scan bar assembly and the transparent surface; and
a height adjustment mechanism for adjusting the height of at least one of the plurality of spacers, the adjustment of the height of the at least one spacer comprising modifying an angle of inclination of the scan bar assembly relative to the transparent surface, wherein the modification of the angle of inclination of the scan bar assembly improves an output quality of the image forming device.

6. The image forming device according to claim 5, wherein the height adjustment mechanism provides for a manual height adjustment of the at least one spacer.

7. A system for improving output quality of an image forming device producing one or more images of one or more documents, the system comprising:
a speckle determination module for determining an amount of speckle in the one or more images;
a speckle comparison module for comparing the amount of speckle with a predefined amount of speckle; and
an angle estimation module for determining one or more angles of inclination of a scan bar assembly in the image forming device based on the comparison of the amount of speckle, wherein the one or more angles of inclination are used to adjust an angle of inclination of the scan bar assembly relative to a transparent surface of the image forming device for improving the output quality of the image forming device.

8. The system according to claim 7, wherein the angle of inclination of the scan bar assembly is adjusted for minimizing the amount of speckle in the one or more images, the minimized speckle being less than or equal to the predefined amount of speckle.

9. The system according to claim 8, wherein the optimum angle of inclination is determined from the estimated one or more angles of inclination.

10. The system according to claim 7, wherein the speckle determination module identifies one or more regions of the one or more documents based on a predefined criterion.

11. The system according to claim 10, wherein the speckle determination module processes only the one or more regions in the one or more documents for determining the amount of speckle.

12. An image forming device comprising:
a transparent surface for supporting one or more documents;
an image capture assembly for capturing images of the one or more documents, the image capture assembly comprising a plurality of sensor elements which receive light reflected from the one or more documents; and
a support assembly for supporting the image capture assembly relative to the transparent surface, the support assembly supporting the image capture assembly such that a normal to the plurality of sensor elements is at a non-zero angle relative to a normal to the transparent surface.

13. The image forming device of claim 12, wherein the support assembly comprises a plurality of spacers located between the image capture assembly and the transparent surface for providing a gap between the image capture assembly and the transparent surface.

14. The image forming device of claim 13, wherein the height of at least one of the plurality of spacers is different from the height of the other of the plurality of spacers.

15. The image forming device of claim 14, wherein the non-zero angle is adjustable.

16. The image forming device of claim 15, wherein the height of at least one of the plurality of spacers is adjustable for adjustment of the non-zero angle to a plurality of non-zero angles.

17. A computer program product for use with a computer, the computer program product comprising a computer usable medium having a computer readable program code embodied therein for improving output quality of an image forming device producing one or more images of one or more documents, the computer readable program code further comprising:
program instruction means for determining an amount of speckle for the one or more images;
program instruction means for comparing the amount of speckle with a predefined amount of speckle; and
program instruction means for indicating whether an adjustment of an angle of inclination of a scan bar assembly in the image forming device is required, based on the comparison, wherein the adjustment of the scan bar assembly improves the output quality of the image forming device.

18. The computer program product according to claim 17, wherein determining the amount of speckle further comprises determining one or more entropy values for the one or more images.

19. The computer program product of claim 17, wherein determining the amount of speckle comprises determining the amount of speckle for the one or more images at a plurality of angles of inclination of the scan bar assembly.

20. The computer program product of claim 19 further comprising identifying an optimum angle of inclination of the scan bar assembly, the optimum angle of inclination being identified from the plurality of angles of inclination, wherein the determined amount of speckle is less than or equal to the predefined amount of speckle at the optimum angle of inclination.
